(19) United States
(12) Patent Application Publication
(10) Pub. No.: US 2006/0271987 A1
(43) Pub. Date: Nov. 30, 2006

(54) Method and system for providing low cost set-top box

(75) Inventors: Blane Eisenberg, Saratoga, CA (US); William B. May, JR., Sunnyvale, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/138,971

(22) Filed: May 26, 2005

(51) Int. Cl. H04N 7/173; H04N 7/18

(52) U.S. Cl. 725/111; 725/112; 725/80; 725/81

(57) ABSTRACT

A system and method for establishing communication between a remote Internet resource and a media device is provided. The connection is established through a cable card providing the connection between the remote Internet resource and the media device. The cable card comprises a cable card socket that has an interface to receive the encoded information over the IP connection, decrypt it and send it to the media device, through a cable card connector. The use of the cable card reduces cost, power supply and the space occupied. It also ensures that an improved quality of communication is achieved at an affordable cost.

### BACKGROUND OF THE INVENTION

1. Field of Invention

Embodiments of this invention relate in general to communication systems; and more specifically, to a low-cost, bidirectional communication device, for providing Internet information (e.g. information from a service provider, world wide Internet information, etc.) on a media device.

2. Description of the Background Art

Internet access over a media device, typically a television set, can be accomplished by using a set-top box. The set top box receives the encoded video over the IP connection, and then converts the information into analog output signals. It is commonly known as an IP set-top box for this reason. In addition to decoding and rendering broadcast TV signals, an IP set-top box can provide functionalities such as video-on-demand (VOD), electronic program guide (EPG), digital-rights management (DRM), and a variety of interactive and multimedia services. IP set-top boxes can support in-demand features such as Web browsing, e-mail and viewing e-mail attachments, advanced multimedia codes, home networking, personal computer connectivity, gateway functionality, instant messaging (IM), and real-time voice-over-IP (VoIP).

However, a conventional IP set-top box requires an external power supply that increases the power consumption for the communication process. Further, the IP set-top box is used as a separate box, which increases the extra space occupied by the instrument. Moreover, the components required to decode the compressed video and convert the signals to an analog or higher-speed digital signal to be sent to the media device, increases the cost of the device. In order to promote the interoperability between different vendors content protection systems, the FCC has mandated an interface called “Cable Card” to allow cable companies to provide a small device to allow for encrypted cable reception with a Set Top Box.

Existing communications systems for providing an Internet connection over an IP set-top box use a higher level of integration, i.e., combining more parts into one chip. This improves the cost effectiveness associated with the device. However, combining more parts into one chip requires the conversion of one form of a signal into another, in order to connect to the television set.

### BRIEF DESCRIPTION OF THE DRAWINGS

FIG. 1 illustrates a basic network, suitable for use in an exemplary embodiment of the present invention.

FIG. 2 is a functional block diagram, illustrating the communication between a remote Internet resource and a media device, according to an exemplary embodiment of the invention.

FIG. 3 is a flowchart, depicting the method steps involved in establishing communication between a remote Internet resource and a media device, according to various exemplary embodiments of the invention.

### DETAILED DESCRIPTION OF EMBODIMENTS OF THE INVENTION

Various embodiments of the invention provide a system and method for establishing unidirectional or bidirectional communication between a remote Internet resource and a media device (e.g., a television, a computer, a set box, etc.) by using a cable card. The cable card resembles an IP set-top box in its mechanical and electrical form. This is achieved by creating a decrypting card that fits into a cable card socket with an interface to receive the information over an IP connection. The decrypted information is sent to the media device by using a cable connector. The use of the cable card reduces the cost of communication, which also reduces the extra space required for placing the set-top box. The cable card does not require an external power supply, nor the conversion of one form of signal to another. This in turn, improves the quality of communication. It is to be understood that the Internet information provided by the Internet resource for various embodiments of the invention may be any suitable information (e.g., audio and/or video signal) from any suitable Internet resource (e.g., a local Internet service provider, the extended, world wide Internet, etc.).

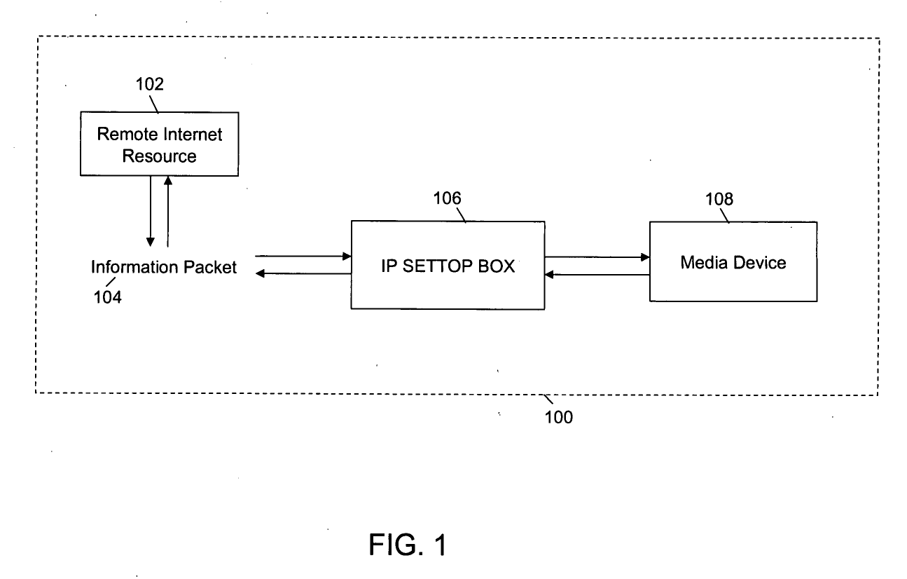

FIG. 1 illustrates a basic network, suitable for use in an exemplary embodiment of the present invention. System 100 shows the communication channel between a remote Internet resource 102 and a media device 108. In an exemplary embodiment of the invention, the media device includes, but is not limited to, a television set and a computer. Remote Internet resource 102 provides information by using an Internet Protocol (IP) in the form of an audio signal, a video signal and so forth. The information can be received as an information packet 104 by an IP set-top box 106. In an embodiment of the invention, remote Internet resource 102 can be a broadband network, a wired Ethernet network, a wireless Ethernet network and so forth. In various embodiments of the invention, information packet 104 is encoded as IP packet. IP set-top box 106 provides an interface between a television set and a broadband network, by decoding information packet 104 such as encoded video, over an IP connection. Interactive and multimedia services can also be provided via information packet 104. In addition to decoding and rendering broadcast TV signals, IP set top box 106 can provide functionalities such as video-on-demand (VOD), electronic program guide (EPG), digital-rights management (DRM), and a variety of interactive and multimedia services. IP settop box 106 can support features such as Web browsing, e-mail and viewing e-mail attachments, advanced multimedia codes, home networking, personal computer connectivity, gateway functionality, instant messaging (IM), and real-time voice-over-IP (VoIP).

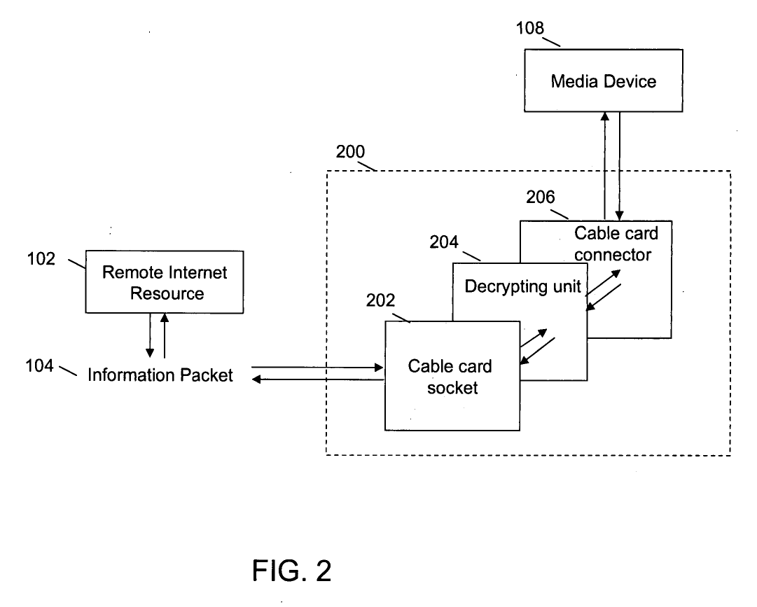

FIG. 2 is a functional block diagram illustrating the communication between remote Internet resource 102 and a media device 108, according to an exemplary embodiment of the invention. FIG. 2 includes a remote Internet resource 102, an information packet 104, a cable card 200, and a media device 108. Remote Internet resource 108 provides information over the Internet, which is received by cable card 200 as information packet 104.

Cable card 200 includes a cable card socket 202, a decrypting unit 204 and a cable card connector 204. Cable card 200 provides a connection between remote Internet resource 102 and media device 108. Cable card 200 is connected to cable card socket 204 Cable card socket 202 provides an interface for receiving information packet 104. In various embodiments of the invention, information packet 104 is encoded. According to an exemplary embodiment of the invention, the interface provided by the cable card socket 202 includes atleast one wired Ethernet, or a wireless interface. The information packet received is then passed to decrypting unit 204, which converts the encoded IP-based information packet into the cable signal format. The decrypted information is then passed to media device 108 through cable card connector 206. In various embodiments of the invention, decrypting unit 204 ‘fools’ the media device such as a TV set, into thinking that the decrypted information is coming in via a cable, when in fact, it is coming in over the Internet. It is to be understood that in accordance with various embodiments of the present invention, the steps of decryption may vary depending on the type of encryption system employed, which may be any suitable encryption system in accordance with embodiments of the invention. It is to be further understood that embodiments of the invention provide for the content of any information (i.e., Internet information) to be either encrypted or not encrypted.

In an exemplary embodiment of the invention, cable card connector 206 and/or the decrypting unit 204 may have any suitable associated connectors (e.g., Ethernet female connectors and so forth. In various embodiments of the invention, decrypting unit 204 may be inserted into a set-top box associated with the media device.

In an embodiment of the invention, the cable card 200 can slide into a slot in the TV set, thereby reducing the extra space required for such devices. In another embodiment of the invention, cable card 200 can be inserted into a set-top box, for example, IP set-top box 106 on top of the TV set.

According to an exemplary embodiment of the invention, the information displayed on media device 108 contains an EPG. The information can be displayed by using mechanisms such as hypertext markup language (HTML) pages, program and system information protocol (PSIP/SI) streams and so forth. In various embodiments of the invention, the system elements of system 200 can be implemented as software, hardware, firmware, or their combination thereof.

According to various embodiments of the invention, the communication between remote Internet resource 102 and media device 108 may be unidirectional, or bidirectional, i.e., the information can be sent from remote Internet source 102 to media device 108, and vice-versa.

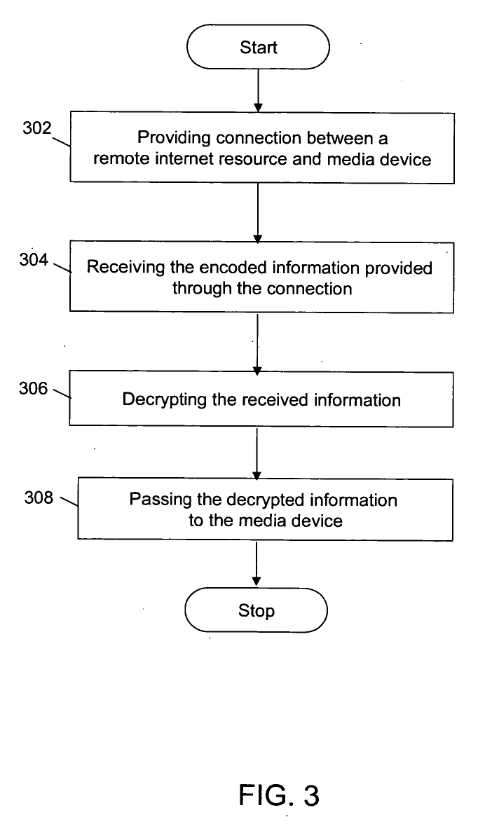

FIG. 3 is a flowchart, depicting the method steps involved in establishing communication between remote Internet resource 102 and media device 108, according to various exemplary embodiments of the invention. A connection is established for providing encoded information from a remote Internet resource 102 to a media device at step 302. The encoded information is received through the provided connection at step 304. The information is decrypted at step 306. If an MPEG2 stream is being transmitted and/or received, the information may be decrypted at step 306 to generate a cable signal format. The decrypted information is passed to media device 108 at step 308. In an embodiment of the invention, the communication between remote Internet device 102 and media device 108 can be bidirectional.

To summarize, various embodiments of the invention provide a cable card for converting an IP-based information packet into a cable signal format, to enable the viewing of this information over a media device such as a TV. In an embodiment of the invention, the cable card can slide into a slot in the TV set, thereby reducing the extra space required for such devices. In another embodiment of the invention, the cable card can be inserted into a set-top box on top of the TV set. In various embodiments of the invention, no additional power socket is required for power supply to the cable card, thereby reducing power utilization. Further, a conversion to analog or any other signal may not be required, thereby improving the quality of the communication.

Although the invention has been discussed with respect to specific embodiments thereof, the embodiments are merely illustrative, and not restrictive, of the invention.

Specific protocols have been used to describe embodiments, but other embodiments can use additional transmission protocols or standards. The present invention can operate between any two processes or entities such as users, devices, functional systems or combinations of hardware and software. Peer-to-peer networks and any other networks or systems, where the roles of client and server are switched, change dynamically, or are not even present, are within the scope of the invention.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A system for establishing communication between a media device and a remote Internet resource, the system comprising
a cable card socket for providing an interface for receiving encoded information from remote Internet resource;
a decrypting unit for decrypting the received encoded information; and
a cable card connector for passing the decrypted information to a media device.

2. The system of claim 1, wherein the interface for receiving the encrypted information comprises an Ethernet connection.

3. The system of claim 1, wherein the communication between the remote Internet resource and the media device is in a direction selected from the group of directions consisting of unidirectional and bidirectional.

4. The system of claim 1, wherein the information sent to the media device is selected from the group consisting of an electronic program guide, service information, and combinations thereof.

5. The system of claim 1 additionally comprising a media device disposed in said cable card socket.

6. A method for establishing communication between a media device and a remote Internet resource, the method comprising
providing a connection between the remote Internet resource and the media device;
receiving encoded information through the connection provided;
decrypting the received encoded information; and
passing the decrypted information to the media device.

7. The method of claim 6, wherein the method for establishing the communication is in a direction selected from the group of directions consisting of unidirectional and bidirectional.

8. The method of claim 6, wherein the receiving the encoded information comprises receiving the encoded information from atleast an Ethernet connection.

9. The method of claim 6, wherein the information sent to the media device is selected from the group consisting of an electronic program guide, service information, and combinations thereof.

10. An apparatus for establishing communication between a media device and a remote Internet resource, the apparatus comprising
means for providing a connection between the remote Internet resource and the media device;
means for receiving encoded information through the connection provided;
means for decrypting the received encoded information; and
means for passing the decrypted information to the media device.
